(19) United States
(12) Patent Application Publication
(10) Pub. No.: US 2008/0195316 A1
(43) Pub. Date: Aug. 14, 2008

(54) SYSTEM AND METHOD FOR MOTION ESTIMATION USING VISION SENSORS

(75) Inventor: Kailash Krishnaswamy, Little Canada, MN (US)

Correspondence Address: HONEYWELL INTERNATIONAL INC., 101 COLUMBIA ROAD, P O BOX 2245, MORRISTOWN, NJ, 07962-2245, US

(73) Assignee: Honeywell International Inc., Morristown, NJ (US)

(21) Appl. No.: 11/673,893

(22) Filed: Feb. 12, 2007

(51) Int. Cl. G01C 21/16

(52) U.S. Cl. 701/213; 701/220

(57) ABSTRACT

A motion estimation system is provided. The motion estimation system comprises two image sensors, each image sensor configured to obtain a first image at a first time and a second image at a second time; an inertial measurement unit (IMU) configured to obtain motion data for the time period between the first time and the second time; and a processing unit coupled to the IMU and the two image sensors, wherein the processing unit is configured to estimate motion by comparing the location of one or more features in the two first images with the location of the one or more features in the respective two second images, wherein the processing unit determines the location of the one or more features in at least one of the second images based at least in part on the IMU data for the time period between the first time and the second time.

### CROSS-REFERENCE TO RELATED APPLICATIONS

This application is related to co-pending U.S. patent application Ser. No. __/______, filed on ______ entitled “SENSOR FUSION FOR NAVIGATION”, attorney docket number H0013072-5607, hereby incorporated herein by reference, and referred to herein as the “'13072 Application”.

### BACKGROUND

The need to know one's location arises in many situations. For example, an operator of an aircraft, spacecraft, land vehicle, etc. needs to know the location of the vehicle or craft in order to properly maneuver the vehicle and avoid dangerous conditions. In addition, unmanned vehicles, such as unmanned aerial vehicles (UAV) or robots, etc. also need accurate position and velocity information in order to properly navigate an area.

Various systems have been developed to provide the needed position and/or velocity data. One such system uses an inertial measurement unit (IMU) to measure acceleration in a plurality of directions. The measured accelerations are then used to determine position and velocity in each of the measured directions. Unfortunately, the IMU measurements are subject to integration drift which negatively affects the accuracy of the IMU measurements. Therefore, a mechanism must be used to update the IMU measurements or otherwise improve the accuracy of the position and velocity data. One such mechanism involves the use of global positioning system (GPS) satellite data. The GPS data is used periodically to correct for errors in the IMU measurements. However, GPS satellite signals are not always available. For example, a GPS satellite signal may not be available when a vehicle is traveling in a city among tall buildings. When the GPS signal is not available, the IMU measurements are not updated.

### SUMMARY

In one embodiment, a motion estimation system is provided. The motion estimation system comprises two image sensors, each image sensor configured to obtain a first image at a first time and a second image at a second time; an inertial measurement unit (IMU) configured to obtain motion data for the time period between the first time and the second time; and a processing unit coupled to the IMU and the two image sensors, wherein the processing unit is configured to estimate motion by comparing the location of one or more features in the two first images with the location of the one or more features in the respective two second images, wherein the processing unit determines the location of the one or more features in at least one of the second images based at least in part on the IMU data for the time period between the first time and the second time.

### DRAWINGS

FIG. 1 is a high level block diagram depicting a motion estimation system according to one embodiment of the present invention.

FIG. 2 is an exemplary diagram depicting the location of an object at different times as detected by vision sensors according to one embodiment of the present invention.

FIG. 3 is a flow chart depicting a method of estimating motion using vision sensors according to one embodiment of the present invention.

### DETAILED DESCRIPTION

In the following detailed description, reference is made to the accompanying drawings that form a part hereof, and in which is shown by way of illustration specific illustrative embodiments in which the invention may be practiced. These embodiments are described in sufficient detail to enable those skilled in the art to practice the invention, and it is to be understood that other embodiments may be utilized and that logical, mechanical and electrical changes may be made without departing from the scope of the present invention. It should be understood that the exemplary method illustrated may include additional or fewer steps or may be performed in the context of a larger processing scheme. Furthermore, the method presented in the drawing figures or the specification is not to be construed as limiting the order in which the individual steps may be performed. The following detailed description is, therefore, not to be taken in a limiting sense.

Embodiments of the present invention enable accurate motion estimates even in the absence of a global positioning system satellite signal. In particular, embodiments of the present invention use an inertial measurement unit in conjunction with a stereo vision sensor to obtain the accurate motion estimates. Furthermore, embodiments of the present invention improve the processing rate necessary to use the stereo vision sensor to obtain motion estimates.

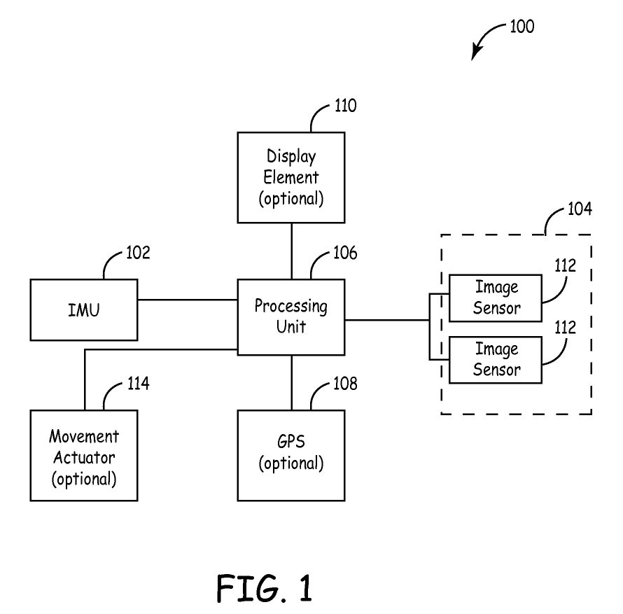

FIG. 1 is a high level block diagram depicting a motion estimation system 100 according to one embodiment of the present invention. System 100 includes a processing unit 106, an inertial measurement unit (IMU) 102, and a stereo vision sensor 104. Stereo vision sensor 104 and IMU 102 are each coupled to processing unit 106 and provide input data to processing unit 106 for estimating motion (e.g. position and/or velocity).

In this example, IMU 102 measures motion in six degrees of freedom. In particular, IMU 102 includes sensors to measure acceleration along three orthogonal coordinate axis and angular acceleration about each of the three orthogonal axes. For example, IMU 102 can include, but is not limited to, three linear accelerometers configured to obtain acceleration along the three coordinate axes, and three gyroscopes to measure angular acceleration about the same three coordinate axes. In other words, the gyroscope measurements are used to estimate attitude or orientation of a vehicle and the accelerometer measurements are used to estimate position and velocity, including the effects of gravity. Therefore, IMU 102 provides data to processing unit 106 which is used to determine position based on the motion measured by IMU 102.

However, measurements provided by IMU 102 suffer from integration drift. In other words, position and velocity are obtained by integrating the acceleration measurements provided by IMU 102. This integration increases errors in position and velocity due to errors in the measured acceleration. Acceleration measurements can suffer from interference (i.e. noisy signals) and the accelerometers and gyroscopes often have a certain level of bias associated with them. For example, a bias of 1 milli-g (9.8/1000 m/s²) means that even though a vehicle in which system 100 is located is stationary, sensors in IMU 102 will measure 1 milli-g of acceleration. This error is further magnified as the measured acceleration is integrated to obtain position and velocity. Therefore, the calculated position based on IMU 102 measurements becomes increasingly less reliable with time.

Positions based on IMU 102 measurements can be corrected or updated with measurements from an optional Global Positioning System (GPS) sensor 108. Position data from GPS sensor 108 does not drift as with data from IMU 102. However, GPS data is not always available. For example, the GPS satellite signal can be lost when traveling near moist trees, tall buildings, etc. In such cases, the measurements from IMU 102 can not be updated by data from GPS sensor 108 and the calculated position becomes increasingly unreliable the longer the GPS satellite signal is unavailable.

Positions based on IMU 102 can also be updated or corrected with measurements from stereo vision sensor 104. Stereo vision sensor 104 can be used in conjunction with GPS sensor 108. For example, stereo vision sensor 104 can be used whenever a GPS satellite signal is unavailable or concurrently with GPS sensor 108 regardless of availability of a GPS satellite signal. Alternatively, GPS sensor 108 can be omitted, in some embodiments. In such embodiments, data from IMU 102 is only updated with measurements from stereo vision sensor 104.

Stereo vision sensor 104 comprises at least two image sensors 112 each configured to obtain images of an area near the system 100. Image sensors 112 are implemented as any appropriate device for collecting image data including, but not limited to, a visible light camera, a laser system, an infrared camera, and any other existing or later developed imaging technology. By correlating the location of features in an image obtained from each sensor at a first moment in time to the location of features in an image obtained from each sensor at a second moment in time, processing unit 106 is able to determine the position and velocity of the vehicle in which system 100 is located, using techniques known to one of skill in the art. Although the position measurements obtained from stereo vision sensor 104 suffer from less drift than measurements from IMU 102, measurements from stereo vision sensor 104 are time intensive. For example, correlation of features can take up to 30 seconds to complete using conventional correlation techniques. The amount of time required for conventional techniques, therefore, renders stereo vision sensor 104 ineffective for use in many vehicles, especially in vehicles moving at relatively high velocities compared to the time required for correlation using conventional techniques.

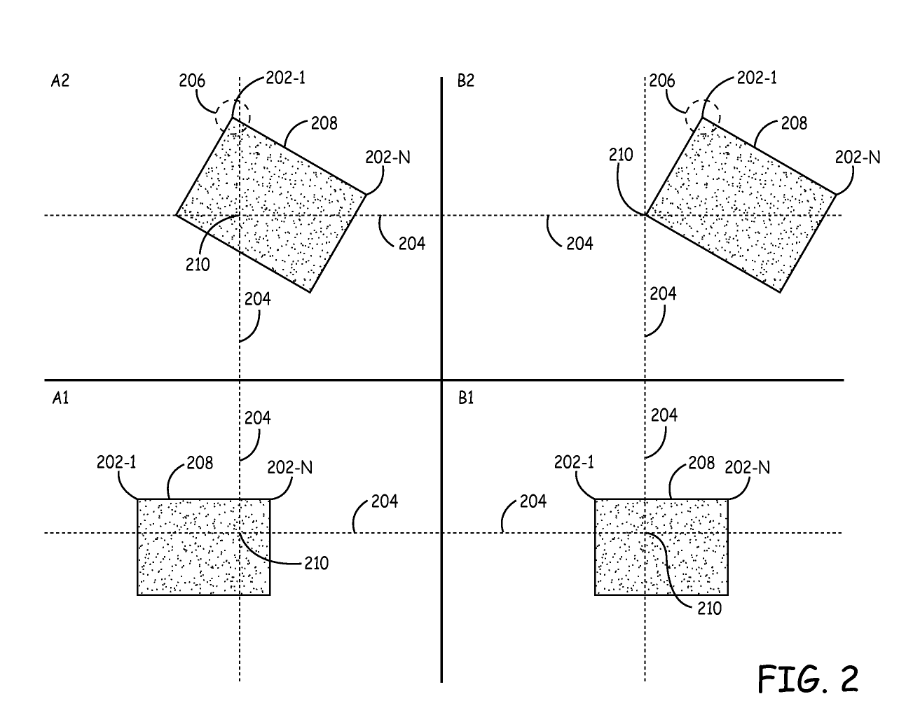

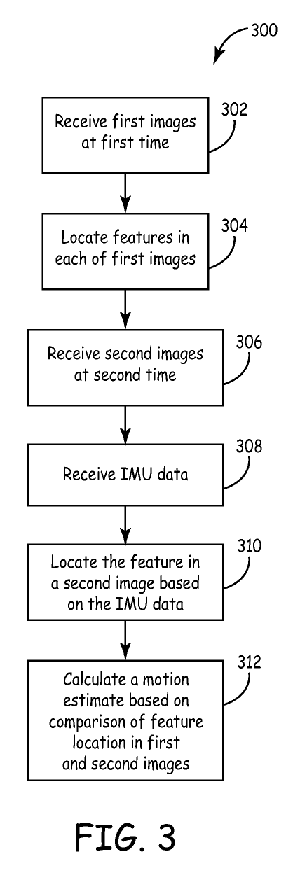

Embodiments of the present invention, however, enable a relatively quick correlation process compared to conventional methods. Therefore, embodiments of the present invention enable the effective use of stereo vision sensor 104 to update or correct measurements obtained from IMU 102. In particular, processing unit 106 is configured to estimate the location of features in images obtained at the second moment in time based on data received from IMU 102 and the location of features in images obtained at the first moment in time. The estimation of the location of features in the second images is described in more detail below with regards to FIGS. 2 and 3. Therefore, processing unit 106 is able to locate the features in the second images quicker by searching for the features in a smaller area located around an estimated location of the features. Once the actual location of the features is identified, processing unit 106 can calculate the change in position of the vehicle by using techniques known to one of skill in the art.

Processing unit 106 uses instructions for carrying out the various process tasks, calculations, and generation of signals and other data used in the operation of system 100, such as to correlate the location of features in images and to determine the velocity and position of the vehicle in which system 100 is located. The instructions can be implemented in software, firmware, analog or digital electronics, or any computer readable instructions. These instructions are typically stored on any appropriate computer readable medium used for storage of computer readable instructions or data structures. Such computer readable media can be any available media that can be accessed by a general purpose or special purpose computer or processor, or any programmable logic device.

Suitable computer readable media may comprise, for example, non-volatile memory devices including semiconductor memory devices such as EPROM, EEPROM, or flash memory devices; magnetic disks such as internal hard disks or removable disks (e.g., floppy disks); magneto-optical disks; CDs, DVDs, or other optical storage disks; nonvolatile ROM, RAM, and other like media. Any of the foregoing may be supplemented by, or incorporated in, specially-designed application-specific integrated circuits (ASICs). When information is transferred or provided over a network or another communications connection (either hardwired, wireless, or a combination of hardwired or wireless) to a computer, the computer properly views the connection as a computer readable medium. Thus, any such connection is properly termed a computer readable medium. Combinations of the above are also included within the scope of computer readable media.

Due to the quicker correlation time, system 100 is able to use data from stereo vision sensor 104 to correct or update the position calculated based on data from IMU 102. In some embodiments, the calculated position based on data from IMU 102 is combined with the calculated position from stereo vision sensor 104. In other embodiments, the calculated position from stereo vision sensor 104 is used in place of the calculated position based on data from IMU 102. In such embodiments, IMU 102 is essentially used only to estimate the location of features in images captured by stereo vision sensor 104.

In operation, IMU 102 measures acceleration of a vehicle in six degrees of freedom. The measurements from IMU 102 are passed to processing unit 106. In addition, images captured from each image sensor 112 in stereo vision sensor 104 are passed to processing unit 106. In particular, each of two sensors in stereo vision sensor 104 captures an image at a time T1 and at a second later time T2. Processing unit 106 is configured to locate one or more features in each of the two images captured at time T1. Processing unit 106 also correlates the location of the one or more features in one of the two images with the location of the one or more features in the other image.

Processing unit 106 is also configured to calculate an estimated position and velocity using the measured acceleration from IMU 102. The estimated position and velocity is used by processing unit 106 together with the location of the one or more features in the images captured at time T1 to estimate the location of the one or more features in at least one of the images captured at time T2. Processing unit 106 then determines the actual location of the one or more features in the image captured at time T2 by focusing on a small area around the estimated position. The small area is defined by the possible error in the measurements of IMU 102. Once the actual location of the one or more features is determined, processing unit 106 calculates the position and velocity of the vehicle based on a comparison of the location of the one or more features between images captured at time T1 and the images captured at time T2 using techniques known to one of skill in the art.

Processing unit 106 then combines the estimated positions and velocities from IMU 102 and stereo vision sensor 104 to obtain a more accurate estimate in some embodiments. Alternatively, processing unit only uses the motion estimate from stereo vision sensor 104. The more accurate estimate is then optionally displayed on a display element 110, in some embodiments. For example, an automobile using system 100 can use display element 110 to display to a driver of the automobile where the vehicle is located on a map. In other embodiments, processing unit 106 uses the more accurate estimate to determine the necessary actions to take in order to reach a programmed destination. In some such embodiments, processing unit 106 generates control signals which are sent to one or more movement actuators 112 to control the movement of the vehicle. For example, processing unit 106 can control the flight of an unmanned aerial vehicle (UAV) based on control signals transmitted to movement actuators (such as the throttle, wing flaps, etc.) in the UAV to control the pitch, yaw, thrust, etc. of the UAV.

FIG. 2 is an exemplary diagram depicting the location of an object 208 at different times as detected by a stereo vision sensor (e.g. stereo vision sensor 104 in FIG. 1) according to one embodiment of the present invention. In particular, a first image sensor captures image A1 at time T1 and image A2 at time T2. Similarly, a second image sensor captures image B1 at time T1 and image B2 at time T2. The image sensors are implemented as any appropriate device for collecting image data including, but not limited to, a visible light camera, a thermographic camera, a spectrometer, an infra-red sensor, a millimeter wave radar system, and any other existing or later developed imaging technology. Also, images A1, B1, A2, and B2 are provided by way of explanation and not by way of limitation. It is to be understood that object 208 and images A1, B1, A2, and B2 will vary in operation depending on the area near the vehicle in which a motion estimating system (e.g. system 100) is located. In particular, although object 208 is shown as a rectangle in FIG. 2, it is to be understood that in other embodiments the object 208 can be any appropriate object from which a vehicles relative position can be determined. For example, object 208 can be a tunnel, building, tower, tree, river, etc.

Object 208 is comprised of a plurality of features 202-1 . . . 202-N. A feature, as used herein, refers to any set of one or more pixels that have a high contrast with respect to the surrounding pixels in images A1, B1, A2, and B2. Also shown in each of the images A1, B1, A2, and B2 are coordinate axes 204. Coordinate axes 204 are provided for purposes of explanation, but are not necessary for operation of embodiments of the present invention. In particular, coordinate axes 204 help demonstrate the relative position of object 208 in each of images A1, B1, A2, and B2.

In operation, images A1 and B1 are each obtained by a sensor (e.g. sensors 112 in FIG. 1) at time T1. As can be seen in FIG. 2, object 208 is offset differently from center 210 in image A1 than in image B1. This difference is due to the relative position of the two sensors which capture images A1 and B1. The two image sensors are fixed on a rigid bar and set apart from each other. Once images A1 and B1 are captured, a processing unit (e.g. processing unit 106) locates features 202-1 . . . 202-N in each of images A1 and B1 and correlates their respective locations. For example, the processing unit correlates the location of feature 202-1 in image A1 with the location of feature 202-1 in image B1. Any appropriate technique can be used for locating features 202-1 . . . 202-N, such as the Harris corner detector or the Kanade-Lucas-Tomasi (KLT) corner detector.

At time T2, images A2 and B2 are captured. Once images A2 and B2 are captured, the processing unit locates and correlates features 202-1 . . . 202-N in at least one of images A2 and B2 with one of images A1 and B1. For example, in this example, the processing unit locates features 202-1 . . . 202-N in image A2 and correlates their location with features 202-1 . . . 202-N in image A1. Once the features are correlated, the position and attitude of the vehicle can be determined using techniques known to one of skill in the art. This process can be very time intensive because of the changes in position of object 208 from time T1 to time T2.

For example, in this embodiment, the vehicle has banked and turned to the left as well as pitched downward. The movement of the vehicle causes object 208 as depicted in image A2, for example, to move and rotate to the right, and to move up in image A2. In addition, the vehicle has moved toward object 208 causing object 208 to be larger in image A2. Therefore, features 202-1 . . . 202-N in image A2 are not located near the original position (e.g. pixel location) of features 202-1 . . . 202-N in image A1. Locating and correlating features 202-1 . . . 202-N requires large amounts of processing time in conventional systems. Although the process of correlating features in an image captured at time T2 with an image captured at time T1 is time intensive in conventional systems, embodiments of the present invention enable a relatively quick correlation of features.

The processing unit uses data received from an IMU (e.g. IMU 102 in FIG. 1) to determine an approximate location of features 202-1 . . . 202-N in figures A2 and B2. For example, the processing unit uses the location of features 202-1 in figure A1 as a starting point and propagates the location of feature 202-1 forward based on data received from the IMU over the time period between time T1 and time T2. In this embodiment, in propagating the location forward, the processing unit also identifies area 206 in which feature 202-1 is located. Area 206 results from the known approximate error of measurements obtained from the IMU. For example, if the IMU measures a lateral movement of 2.0 meters to the right over a time period of 1 second but has a known error of 0.1 meters/second, the actual location of feature 202-1 is between 1.9-2.1 meters to the right of its location at time T1. The processing unit then evaluates the pixels in area 206 to identify the actual location of feature 202-1 in image A2. Alternatively, the processing unit evaluates pixels successively further away from the estimated location of feature 202-1, starting with pixels adjacent to the estimated location, until the actual pixel location is identified. In such embodiments, the approximate error in the IMU data does not need to be known.

The processing unit can use conventional techniques, such as KLT corner detection, to locate feature 202-1 in area 206. However, by focusing on area 206 of image A2 rather than the entire image, the processing unit is able to locate feature 202-1 much quicker than in conventional systems which have to search larger areas. The processing unit uses IMU data to estimate the location of each of features 202-1 . . . 202-N. It is not necessary to correlate both of images A2 and B2 with images A1 and B1, respectively, because once the actual location of features in one of images A2 and B2 are located, the processing unit can calculate position and velocity which can be used to determine the actual location of the features in the other of images A2 and B2.

FIG. 3 is a flow chart depicting an exemplary method 300 of estimating motion using vision sensors according to one embodiment of the present invention. Method 300 can be used in a motion estimating system such as system 100 above. In particular, in some embodiments, method 300 is implemented in a computer readable medium for use by a processing unit (such as processing unit 106). At 302, image data is received for two images captured at a first time T1. In particular, in this embodiment, two image sensors (e.g. sensors 112) each capture an image at time T1 and pass the data to a processing unit. At 304, the processing unit locates one or more features in both of the images. It is to be understood that the one or more features are the same in each of the images with only the relative location and/or size of the features being different. In addition, locating the one or more features includes correlating the relative location of the features in one image with the location of the features in the other image. The features can be located using any technique known to one of skill in the art, such as KLT corner detection or Harris corner detection.

At 306, image data is received for two images captured at a second time T2 from the two image sensors. Time T2 occurs after time T1. In addition, the subject matter of the images captured at time T2 and time T1 is the same. That is, each image captured at a second corresponds to one of the images captured at the first time T1. At 308, motion data is received from an inertial measurement unit (e.g. IMU 102). In particular, acceleration measurements in six degrees of freedom are received by the processing unit in this embodiment. The processing unit evaluates the IMU data to calculate an estimate for position and/or velocity.

At 310, the processing unit estimates the location of the one or more features in at least one of the images captured at time T2. The location estimate is based on the IMU data received at 308 and the location of the features in the images captured at time T1. For example, the processing unit calculates motion that occurred from time T1 to time T2 based on the IMU data. Based on the calculated motion and the pixel location of the one or more features in one of the first images located at 304, the processing unit selects a second pixel location in one of the second images for each of the one or more features.

The processing unit then evaluates pixels near the second pixel location to identify the actual pixel location of the feature. In addition, in some embodiments, the processing unit calculates an area to be searched around the second pixel location of each feature based on the known approximate error in the IMU measurements. By limiting the search to an area defined by the known approximate error, the processing unit searches more efficiently by not unnecessarily evaluating pixels outside the area. In other embodiments, the processing unit does not limit the search to a calculated area. In such embodiments, the processing unit successively evaluates pixels near the second pixel location until the actual pixel location of the corresponding feature is identified, starting with pixels adjacent to the second pixel location. In such embodiments, the approximate error in the IMU data does not need to be known.

The processing unit evaluates pixels using techniques known to one of skill in the art to determine the actual location of the features in at least one of the images captured at time T2. For example, such techniques include but are not limited to the Harris corner detection or KLT corner detection algorithms. In addition, determining the actual location of the features also includes correlating the location of features in at least one of the images captured at time T2 to the location of the features in the corresponding image captured at time T1. In some embodiments, the location of the one or more features is determined in both of the images captured at time T2 based on the IMU data, as described above. However, this is not required. Once the pixel location of features in one of the second images is correlated with the pixel location of the features in the corresponding image obtained at time T1, the change in pixel location can be used to determine the actual pixel location of the features in the other image obtained at time T2.

At 312, the processing unit calculates a motion estimate (e.g. position and/or velocity) based on a comparison of the location of the one or more features in the first images captured at time T1 with the location of the one or more features in the second images captured at time T2 using techniques known to one of skill in the art. In addition, in some embodiments, the processing unit calculates a motion estimate based on the IMU data and combined the IMU motion estimate with the motion estimate based on a comparison of feature location to obtain a composite motion estimate. Similarly, in some embodiments, a GPS signal is also received and the processing unit calculates a motion estimate based on the GPS signal when available. In some such embodiments, the GPS signal and IMU data are used exclusively when the GPS signal is available and the image sensor data is only used when the GPS signal is not available.

Although specific embodiments have been illustrated and described herein, it will be appreciated by those of ordinary skill in the art that any arrangement, which is calculated to achieve the same purpose, may be substituted for the specific embodiment shown. This application is intended to cover any adaptations or variations of the present invention. Therefore, it is manifestly intended that this invention be limited only by the claims and the equivalents thereof.

What is claimed is:

1. A motion estimation system, comprising:
two image sensors, each image sensor configured to obtain a first image at a first time and a second image at a second time;
an inertial measurement unit (IMU) configured to obtain motion data for the time period between the first time and the second time; and
a processing unit coupled to the IMU and the two image sensors, wherein the processing unit is configured to estimate motion by comparing the location of one or more features in the two first images with the location of the one or more features in the respective two second images, wherein the processing unit determines the location of the one or more features in at least one of the second images based at least in part on the IMU data for the time period between the first time and the second time.

2. The motion estimation system of claim 1, wherein the processing unit is further configured to determine a first pixel location of the one or more features in each first image, to select a second pixel location in the at least one second image based on the IMU data, and to evaluate pixels near the second pixel location to identify the actual pixel location of the one or more features in the at least one second image.

3. The motion estimation system of claim 1, further comprising a motion actuator coupled to the processing unit, wherein the movement actuator is configured to control motion based on control signals received from the processing unit.

4. The motion estimation system of claim 1, further comprising a display element coupled to the processing unit, wherein the display element is configured to display motion estimates based on signals received from the processing unit.

5. The motion estimation system of claim 1, wherein each of the two image sensors includes one of a visible light camera, a laser system, or an infrared camera.

6. The motion estimation system of claim 1, wherein the processing unit is configured to combine a motion estimate from the IMU data and a motion estimate from the image sensors to obtain a composite motion estimate.

7. The motion estimation system of claim 1, further comprising a global positioning system (GPS) sensor coupled to the processing unit, wherein the processing unit is configured to estimate motion based on data received from the GPS sensor, IMU, and two image sensors.

8. The motion estimation system of claim 7, wherein the processing unit is configured to estimate motion based on data received from the GPS sensor and IMU when a GPS signal is available and to estimate motion based solely on data from the two image sensors and IMU when the GPS signal is not available.

9. A method of estimating motion, the method comprising:
receiving a first image from each of two image sensors at a first time;
locating one or more features in each of the first images;
receiving a second image from each of the two image sensors at a second time;
receiving data from an inertial measurement unit (IMU) for a time period between the first and second times;
locating the one or more features in at least one of the second images based at least in part on the IMU data; and
calculating a motion estimate based on a comparison of the location of the one or more features in the first images to the location of the one or more features in the second images.

10. The method of estimating motion of claim 9, wherein locating the one or more features includes locating the one or more features using one of a Kanade-Lucas-Tomasi (KLT) corner detection algorithm or a Harris corner detection algorithm.

11. The method of estimating motion of claim 9, wherein locating one or more features in each of the first images includes correlating the relative location of the features in one of the first images with the location of the features in the other first image.

12. The method of estimating motion of claim 9, further comprising combining a motion estimate based on IMU data with the motion estimate based on a comparison of the location of the one or more features in the first images to the location of the one or more features in the second images.

13. The method of estimating motion of claim 9, further comprising:
receiving a global position system (GPS) signal; and
estimating motion based, at least in part, on the GPS signal when the GPS signal is available.

14. The method of estimating motion of claim 9, wherein locating the one or more features in at least one of the second images based, at least in part, on the IMU data includes:
determining a first pixel location of the one or more features in each first image;
selecting a second pixel location in the at least one second image based on the IMU data and the first pixel location; and
evaluating pixels near the second pixel location to identify the actual pixel location of the one or more features in the at least one second image.

15. The method of estimating motion of claim 14, wherein evaluating pixels near the second pixel location includes evaluating pixels in an area around the second pixel location, wherein the size of the area is determined based on the approximate error in the IMU data.

16. A program product comprising program instructions embodied on a processor-readable medium for execution by a programmable processor, wherein the program instructions are operable to cause the programmable processor to:
locate one or more features in each of two first images received at a first time;
evaluate data received from an inertial measurement unit (IMU) for a time period between the first time and a second time;
locate the one or more features in at least one of two second images received at the second time based at least in part on the IMU data;
calculate a motion estimate based, at least in part, on a comparison of the location of the one or more features in the first images to the location of the one or more features in the second images; and
output the calculated motion estimate.

17. The program product of claim 16, wherein the program instructions are further operable to cause the programmable processor to:
calculate a motion estimate based on the IMU data; and
combine the IMU motion estimate with the motion estimate based on a comparison of the location of the one or more features in the first images to the location of the one or more features in the second images.

18. The program product of claim 16, wherein the program instructions are further operable to cause the programmable processor to locate the one or more features using one of a Kanade-Lucas-Tomasi (KLT) corner detection algorithm or a Harris corner detection algorithm.

19. The program product of claim 16, wherein the program instructions are further operable to cause the programmable processor to:
determine a first pixel location of the one or more features in each first image;
select a second pixel location in the at least one second image based on the IMU data and the first pixel location; and
evaluate pixels near the second pixel location to identify the actual pixel location of the one or more features in the at least one second image.

20. The program product of claim 19, wherein the program instructions are further operable to cause the programmable processor to:
evaluate pixels in an area around the second pixel location to identify the actual pixel location of the one or more features in the at least one second image, wherein the area is determined by an approximate error in the IMU data.
